(19) United States
(12) Patent Application Publication
(10) Pub. No.: US 2023/0417714 A1
(43) Pub. Date: Dec. 28, 2023

(54) Data Processing Device, Data Processing Method, Data Processing Program, and Analysis Device

(71) Applicant: Shimadzu Corporation, Kyoto-shi (JP)

(72) Inventor: Yusuke TAMAI, Kyoto-shi (JP)

(21) Appl. No.: 17/926,356

(22) PCT Filed: Mar. 4, 2021
(86) PCT No.: PCT/JP2021/008351

§ 371 Date: Mar. 24, 2023

(30) Foreign Application Priority Data
May 29, 2020 (JP) 2020-094492

(51) Int. Cl. G01N 30/86; G01N 30/72

(52) U.S. Cl. CPC G01N 30/8637; G01N 30/72

(57) ABSTRACT

A data processing device performs a data process on a measured waveform obtained by a prescribed measurement of a sample. The data processing device includes an estimator, a calculator, and a display processor. The estimator estimates a predictive distribution of each peak shape for a corresponding one of a plurality of peak waveforms using a prescribed peak shape model, the plurality of peak waveforms being included in the measured waveform and being close to each other. The calculator calculates a predictive distribution of a quantitative indicator for each of the plurality of peak waveforms based on the predictive distribution of the peak shape estimated by the estimator. The display processor is operable to display the predictive distribution of the quantitative indicator calculated by the calculator.

### TECHNICAL FIELD

The present invention relates to a data processing device, a data processing method, a data processing program, and an analysis device.

### BACKGROUND ART

In an analysis device including a combination of a component separation device and a detector, such as a liquid chromatograph or a gas chromatograph, peaks of impurities, related substances, and the like are frequently superimposed on each other. Thus, peak separation is required before a quantitative analysis. In an analysis using a chromatograph, a peak shape model is used. In the peak shape model, for example, a function such as a Gaussian function or a BEMG function described in NPL 1 is assumed for an individual peak shape, and such functions are mixed. For example, in use of a Gaussian mixture model, it is assumed that a signal waveform can be expressed by a function of Equation (1) below where K is the number of peaks (the number of clusters) assumed.

$$\begin{matrix}[ Math . 1 ] & \\ f ( x ) = {\sum }_{k = 1}^{K} \frac{1}{\sqrt{2 π} {σ}_{k}} exp ( - \frac{{( x - {μ}_{k} )}^{2}}{2 {σ}_{k}^{2}} ) & ( 1 )\end{matrix}$$

Then, μₖ and σₖ, which are parameters, are estimated by maximum likelihood estimation or the like. Here, the shape of each peak is indicated by Equation (2) below.

$$\begin{matrix}[ Math 2 ] & \\ \frac{1}{\sqrt{2 π} {σ}_{k}} exp ( - \frac{{( x - {μ}_{k} )}^{2}}{2 {σ}_{k}^{2}} ) & ( 2 )\end{matrix}$$

If peaks are superimposed on each other, however, great uncertainty remains about the estimation of the shape of each peak and the area of the peak. Prediction of the area and height of the peak (or a component concentration proportional to the area and height) using the above-mentioned maximum likelihood estimation may cause a larger prediction error.

### CITATION LIST

### Non Patent Literature

NPL 1: Arase, Shuntaro, et al. “Intelligent peak deconvolution through in-depth study of the data matrix from liquid chromatography coupled with a photo-diode array detector applied to pharmaceutical analysis.” Journal of Chromatography A, 1469 (2016): 35-47.

### SUMMARY OF INVENTION

### Technical Problem

As described above, in peak separation, multiple Gaussian functions and multiple BEMG functions (NPL 1) are prepared and applied to peak waveforms, to thereby estimate an individual peak shape from the superimposed groups of peaks. In the estimation of each peak shape, however, there is a region in which the peak of a substance (also referred to as “main peak”) and the peak of an impurity (or a related substance) cannot be essentially distinguished from each other. FIG. 1 shows the relation between tailing of the main peak and an impurity peak. As shown in FIG. 1, a peak waveform obtained by superimposing the impurity peak on the main peak without tailing is substantially identical to the peak waveform of the main peak with tailing, and accordingly, these peak waveforms cannot be distinguished from each other. In quantitative analysis of the area of the peak waveform, thus, an area error may occur. Further, in fitting of the peak waveform using a peak shape model, uncertainties such as noise contained in the measured peak waveform may cause an error in the quantitative analysis of the area of the peak waveform. Under the circumstances, there is a users' need for evaluating how much error may occur in a quantitative indicator obtained from a peak waveform and securing a reasonable level of security.

The present disclosure has been made to solve the above problem. An object of the present disclosure is to provide technology capable of securing a reasonable level of security in consideration of an error against a quantitative indicator obtained from a peak waveform.

### Solution to Problem

A data processing device according to an aspect of the present disclosure performs a data process on a measured waveform obtained by a measurement of a sample. The data processing device includes an estimator, a calculator, and a display processor. The estimator outputs a predictive distribution of each peak shape for a corresponding one of a plurality of peak waveforms, which are included in the measured waveform and closely appear to each other, using a peak shape model. The calculator outputs, based on the outputted predictive distribution of the peak shape from the estimator, a predictive distribution of a quantitative indicator for each of the plurality of peak waveforms. The display processor is operable to display the outputted predictive distribution of the quantitative indicator from the calculator.

A data processing method according to another aspect of the present disclosure performs a data process on a measured waveform obtained by a measurement of a sample. The data processing method includes: outputting a predictive distribution of each peak shape for a corresponding one of a plurality of peak waveforms, which are included in the measured waveform and closely appear to each other, using a peak shape model; outputting, based on the outputted predictive distribution of the peak shape, a predictive distribution of a quantitative indicator for each of the plurality of peak waveforms; and displaying the outputted predictive distribution of the quantitative indicator.

A data processing program according to still another aspect of the present disclosure performs a data process on a measured waveform obtained by a measurement of a sample. The data processing program causes a computer to perform the steps of outputting a predictive distribution of each peak shape for a corresponding one of a plurality of peak waveforms, which are included in the measured waveform and closely appear to each other, using a peak shape model; outputting, based on the outputted predictive distribution of the peak shape, a predictive distribution of a quantitative indicator for each of the plurality of peak waveforms; and displaying the outputted predictive distribution of the quantitative indicator.

### Advantageous Effects of Invention

According to the present disclosure, the data processing device is operable to display the predictive distribution of the quantitative indicator for each peak shape. The user can check the predictive distribution of the quantitative indicator in this manner, and accordingly, statistical data on the quantitative indicator can be grasped intuitively with ease. Also, a reasonable level of security can be secured in consideration of an error against the quantitative indicator through such checking.

### BRIEF DESCRIPTION OF DRAWINGS

FIG. 1 shows the relation between tailing of a main peak and an impurity peak.

FIG. 2 is a block diagram showing a functional configuration example of a data processing device.

FIG. 3 is a flowchart showing an example data process.

FIG. 4 is a flowchart showing an example estimation process.

FIG. 5 shows a display example of a predictive distribution of a peak shape when the number of peaks is assumed to be two.

FIG. 6 shows a display example of a predictive distribution of a peak shape when the number of peaks is assumed to be one.

FIG. 7 shows a display example of a predictive distribution of each peak shape when the number of peaks is assumed to be two.

FIG. 8 shows a display example of predictive distributions of peak areas.

FIG. 9 shows a display example of a predictive distribution of an area ratio and a quantile.

FIG. 10 shows a display example of a predictive distribution of each peak shape and a quantile.

FIG. 11 is a block diagram showing a functional configuration example of an analysis device according to a variation of the present embodiment.

### DESCRIPTION OF EMBODIMENTS

Embodiments of the present disclosure will now be described in detail with reference to the drawings. The same or corresponding parts in the drawings have the same reference characters allotted, and description thereof will not be repeated.

### Functional Configuration of Data Processing Device

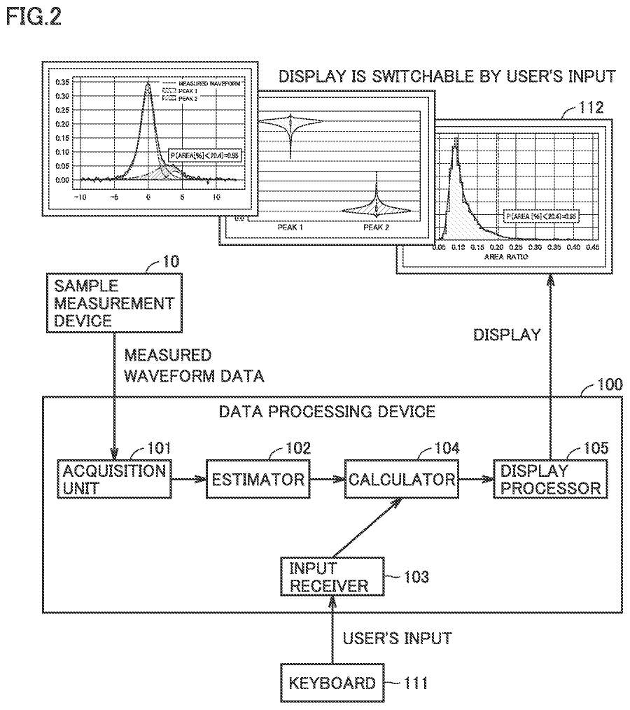

FIG. 2 is a block diagram showing a functional configuration example of a data processing device. As shown in FIG. 2, a data processing device 100 according to the present embodiment is connectable to a sample measurement device 10.

Sample measurement device 10 in the present embodiment is, for example, a chromatograph analyzer (LC, GC) including a combination of a component separation device and a detector, such as a liquid chromatograph or a gas chromatograph. Alternatively, sample measurement device 10 may be a chromatograph mass spectroscope (LC/MS, GC/MS) including a mass spectroscope (MS) as a detector.

Data processing device 100 performs a data process on a measured waveform obtained by a prescribed measurement of a sample. Each peak shape included in the measured waveform corresponds to a corresponding one of substances included in the sample. In the present embodiment, a waveform of a chromatogram obtained through the measurement by the liquid chromatograph analyzer (sample measurement device is assumed as the measured waveform.

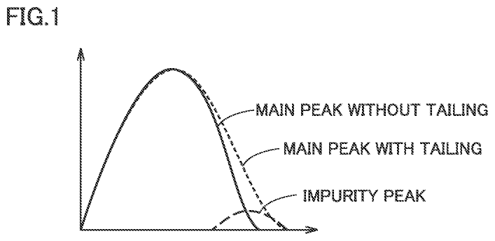

For example, when a sample contains a substance (also referred to as “main component”) and an impurity, a peak corresponding to the main component (also referred to as “main peak”) and a peak corresponding to the impurity (also referred to as “impurity peak”) appear in the measured waveform. When the main peak and the impurity peak are close to each other, distinction between these peaks is difficult (see FIG. 1).

Herein, data processing device 100 includes a hard disk, a central processing unit (CPU), and a memory. The CPU reads a program stored in the hard disk into the memory and executes the program, thereby implementing various functions of data processing device 100. Data processing device 100 is, for example, a personal computer or a workstation.

Data processing device 100 is connected to peripheral devices including a keyboard 111 and a display 112. Data processing device 100 may include an input device such as display 112 and a display device such as display 112.

Data processing device 100 includes an acquisition unit 101, an estimator 102, an input receiver 103, a calculator 104, and a display processor 105. These functions are implemented as the CPU of data processing device 100 executes various programs.

Sample measurement device 10 performs a prescribed measurement of a sample. Acquisition unit 101 obtains a measured waveform. Specifically, acquisition unit 101 obtains a measured waveform obtained by a prescribed measurement performed by sample measurement device 10.

Estimator 102 estimates a predictive distribution of a peak shape for a peak waveform included in the measured waveform using a prescribed peak shape model. In the present embodiment, the prescribed peak shape model is a “K-mixture BEMG function”, which will be described below. The measured waveform is a measured waveform obtained by acquisition unit 101. Sample measurement device 10 may include no acquisition unit 101. In this case, estimator 102 directly obtains the measured waveform obtained by the prescribed measurement performed by sample measurement device 10 and makes an estimate.

In the present embodiment, estimator 102 estimates a predictive distribution of each peak shape by Bayesian estimation. However, the present invention is not limited to the above, and estimator 102 may make an estimate using an estimation technique other than Bayesian estimation.

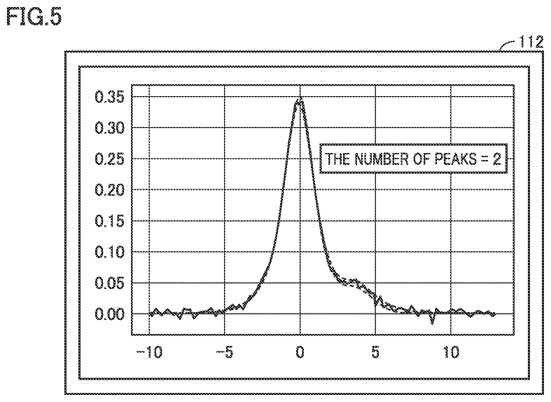

In the present embodiment, the peak waveforms included in the measured waveform include a plurality of peak waveforms that are close to each other. In other words, estimator 102 estimates a predictive distribution of each peak shape for a corresponding one of a plurality of peak waveforms, which are included in the measured waveform obtained by acquisition unit 101 and are close to each other, using a prescribed peak shape model (K-mixture BEMG function). Detailed description will be given below with reference to FIGS. 5 to 7.

Calculator 104 calculates a predictive distribution of a quantitative indicator for each peak waveform based on the predictive distribution of the peak shape estimated by estimator 102. Calculator 104 also calculates a quantile at a threshold in the calculated predictive distribution of the quantitative indicator.

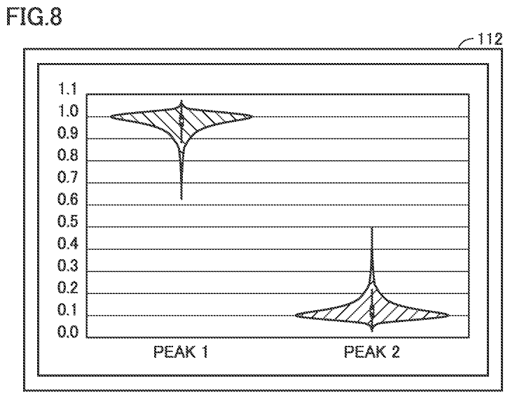

For example, the quantitative indicator is “an area of a peak shape (also merely referred to as “peak area”)”. In other words, the predictive distribution of the quantitative indicator in this case is a predictive distribution of a peak area. Alternatively, the quantitative indicator may be “a ratio of peak areas between peak shapes (also merely referred to as “area ratio”)”. The predictive distribution of the quantitative indicator in this case is the predictive distribution of the area ratio and indicates “a distribution of a ratio of a substance corresponding to each peak shape”. For example, the threshold is “0.95”, and the determined quantile is “20.4%”. Detailed description will be given below with reference to FIGS. 8 to 10.

Display processor 105 is operable to display the predictive distribution of the quantitative indicator calculated by calculator 104. Display processor 105 is also operable to display the quantile calculated by calculator 104. Specifically, display processor 105 causes display 112 to display at least one of the predictive distribution of the quantitative indicator and the quantile calculated by calculator 104. As a result, the predictive distribution of the quantitative indicator and the quantile are displayed on display 112. Detailed description will be given below with reference to FIGS. 8 to 10.

Herein, the user can perform various settings and switch a display by operating keyboard 111. For example, the user can set a threshold by operating keyboard 111.

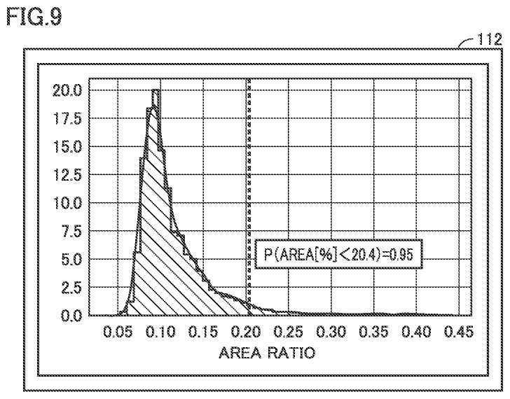

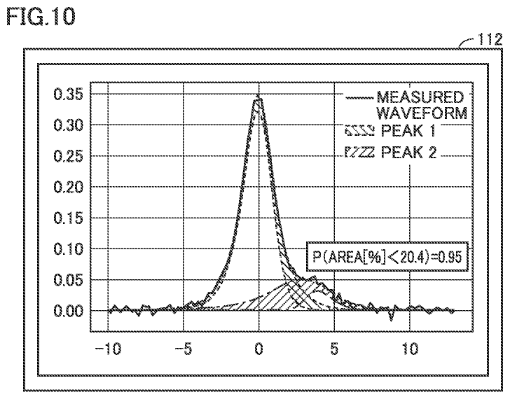

Input receiver 103 receives a user's input. Specifically, input receiver 103 receives an input of a threshold (e.g., 0.95) based on the user's operation. Based on the threshold received by input receiver 103, calculator 104 calculates a quantile, and the quantile is displayed on display 112. For example, display 112 may display a quantile together with a threshold, may display a predictive distribution of an area ratio together with the threshold and the quantile (see FIG. 9, which will be described below), or may display a predictive distribution of a peak shape together with the threshold and the quantile (see FIG. 10, which will be described below).

The user can switch a display of display 112 by operating keyboard 111. For example, the user can operate keyboard 111 to switch the display of the predictive distribution of the area ratio (see FIG. 9, which will be described below) to the display of the predictive distribution of the peak area (see FIG. 8, which will be described below), or switch to the display of the predictive distribution of the peak shape (see FIG. 10, which will be described below).

Data processing device 100 may be connectable to a network such as a local area network (LAN) via a communication interface. In this case, data processing device 100 may connect to sample measurement device 10 via the network. Alternatively, data processing device 100 may connect to multiple sample measurement devices 10 via the network.

The processes performed by acquisition unit 101, estimator 102, input receiver 103, calculator 104, and display processor 105 may be performed by the personal computer as described above, or may be performed by a server device connected to the personal computer via the network. The programs that performs the above processes are installed in the personal computer in the former case, or is installed in the server device in the latter case. The programs that perform the above processes may be downloadable by the server device via the network, or may be stored in a storage medium (e.g., CD or DVD) for distribution.

### Flowchart of Data Process

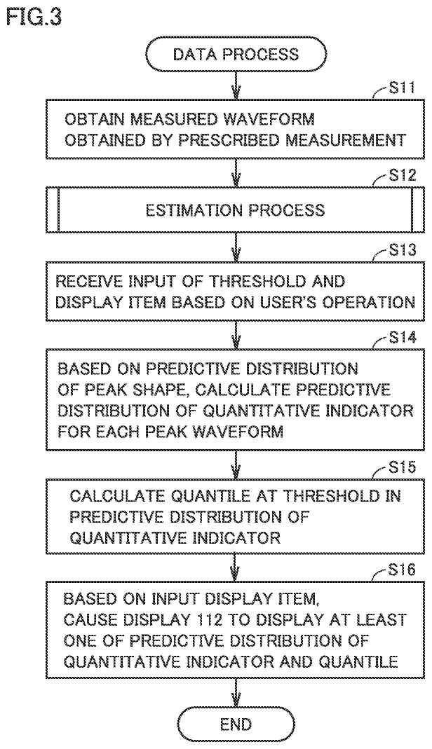

FIG. 3 is a flowchart showing an example data process. As shown in FIG. 3, data processing device 100 performs the data process. The data process is performed on a measured waveform obtained by a prescribed measurement of a sample and is a series of processes performed by acquisition unit 101, estimator 102, input receiver 103, calculator 104, and display processor 105 of data processing device 100.

The data process includes an acquisition process, an estimation process, an input process, a calculation process, and a display process. The acquisition process is performed by acquisition unit 101, the estimation process is performed by estimator 102, the input process is performed by input receiver 103, the calculation process is performed by calculator 104, and the display process is performed by display processor 105. A step will be merely referred to as S below.

The CPU reads the program stored in the hard disk into the memory and executes the program. The data process is performed through the execution of a data processing program. The acquisition process is performed through the execution of an acquisition processing program. The estimation process is performed through the execution of an estimation processing program. The input process is performed through the execution of an input process program. The calculation process is performed through the execution of a calculation processing program. The display process is performed through the execution of a display processing program.

For example, acquisition unit 101 performs the acquisition process for data (measured waveform) passing between sample measurement device 10 and data processing device 100. The acquisition process is performed through the execution of an acquisition process program.

As the data process starts, data processing device 100 performs the acquisition process at S11, and then, the process proceeds to S12. In the acquisition process, acquisition unit 101 obtains the measured waveform obtained by the prescribed measurement performed by sample measurement device 10.

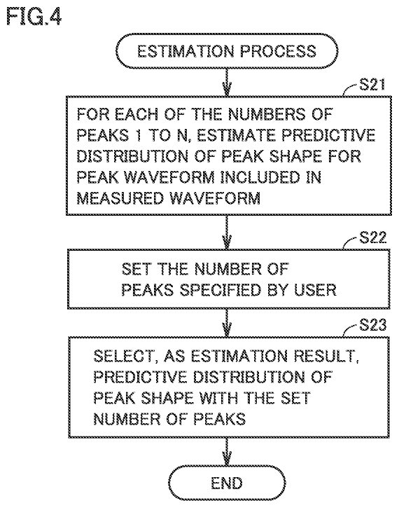

Data processing device 100 performs the estimation process at S12, and then, the process proceeds to S13. In the estimation process, processing shown in FIG. 4 is performed.

FIG. 4 is a flowchart showing an example of the estimation process. As shown in FIG. 4, when the estimation process starts at S21, data processing device 100 estimates a predictive distribution of a peak shape for a peak waveform included in a measured waveform by Bayesian estimation for each of the cases where the number of peaks is assumed to be 1 to N. Then, the process proceeds to S22.

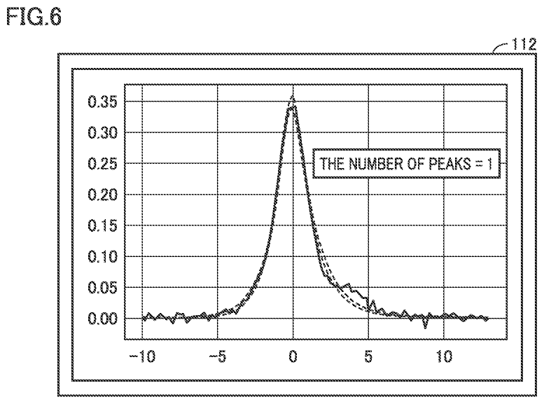

At S22, data processing device 100 sets the number of peaks specified by the user, and then, the process proceeds to S23. For example, the predictive distribution of the peak shape for each of the cases where the number of peaks is 1 to N, calculated at S21, may be displayed on display 112 (see FIGS. 5 and 6, which will be described below). Then, the user specifies whether any of 1 to N is appropriate for the number of peaks. In this case, for example, data processing device 100 sets the number of peaks specified by the user based on the operation of keyboard 111.

At S23, data processing device 100 selects, as an estimation result, the predictive distribution of the peak shape with the number of peaks set at S22. Then, the estimation process ends. For example, when the number of peaks is set to two, data processing device 100 selects, as the estimation result, the predictive distribution of the peak shape for the case where the number of peaks is two, and uses this estimation result in the processes of S13 to S16.

Returning to FIG. 3, data processing device 100 performs the input process at S13, and then, the process proceeds to S14. In the input process, input receiver 103 receives a user's input. Specifically, input receiver 103 receives input of a threshold and a display item based on the user's operation. “Display item” is an item that the user attempts to cause display 112 to display, and may be a quantitative indicator such as a peak area or an area ratio or may be a quantile. For example, when the quantitative indicator “area ratio” is input as the display item, the predictive distribution of the area ratio is displayed on display 112. The threshold is, for example, “0.95”.

At S14 and S15, data processing device 100 performs the calculation process. At S14, calculator 104 calculates a predictive distribution of a quantitative indicator for each peak waveform based on the predictive distribution of the peak shape estimated by estimator 102. Then, the process proceeds to S15. For example, “a predictive distribution of an area ratio” is calculated as the predictive distribution of the quantitative indicator.

At S15, calculator 104 determines a quantile at the threshold in the predictive distribution of the quantitative indicator. Then, the process proceeds to S17. For example, “20.4%” is determined as the quantile at the threshold (0.95) in the predictive distribution of the area ratio. When display of the quantile is not specified at S14, the quantile does not need to be calculated.

Data processing device 100 performs the display process at S16, and then, the data process ends. In the display process, display processor 105 causes display 112 to display at least one of the predictive distribution of the quantitative indicator (e.g., area ratio or the like) and the quantile (e.g., 20.4%) calculated by calculator 104.

As a result, the predictive distribution of the quantitative indicator and the quantile are displayed on display 112. For example, the predictive distribution of the peak area is displayed on display 112 as shown in FIG. 8 which will be described below, “P (area [%]<20.4)=0.95)” is displayed on display 112, which indicates that the area ratio (=the peak area of peak 2/the peak area of peak 1) is less than 20.4% with a probability of 0.95 (95%), together with the predictive distribution of the area ratio as shown in FIG. 9 which will be described below, or the predictive distribution of the peak shape is displayed on display 112 as shown in FIG. 10 which will be described below.

Herein, the user can change the threshold or perform input for changing the display item or the quantitative indicator by operating keyboard 111. When such a change is made, it suffices that data processing device 100 performs the data process again starting from S13. For example, when the user changes the threshold from “0.95” to “0.97”, a threshold “0.97” is input at S13. Data processing device 100 then performs the calculation process of S14 and S15 and the display process of S16 based on the changed threshold.

When the user changes the display item from “peak area” to “peak height”, at S13, the display item “peak height” is input. Data processing device 100 then performs the calculation process of S14 to S16 and the display process of S17 based on the changed display item.

Display processor 105 is not limited to a display processor that performs the process of displaying, as the quantile, the probability that the quantitative indicator is equal to or more than the threshold received by input receiver 103 or performs the process of displaying the probability that the quantitative indicator is equal to or less than the threshold received by input receiver 103. Alternatively, display processor 105 may be a display processor that performs the process of displaying, as the quantile, the probability that the quantitative indicator is more than the threshold received by input receiver 103 or performs the process of displaying, as the quantile, the probability that the quantitative indicator is less than the threshold received by input receiver 103. The quantile is a numerical value calculated based on the input threshold and is, for example, a statistic indicating some degree of risk or degree of safety.

Calculator 104 may also calculate, based on the predictive distribution of the peak shape estimated by estimator 102, first and second predictive distributions that are related to each other and are based on a quantitative indicator for each peak waveform. In this case, display processor 105 is operable to change the display mode of the first and second predictive distributions based on the user's selection received by input receiver 103.

“First and second predictive distributions that are related to each other and are based on a quantitative indicator” may be based on the same quantitative indicator or may be any predictive distributions related to each other. For example, calculator 104 may calculate the predictive distribution of the peak area of peak 1 as the first predictive distribution and calculate the predictive distribution of the peak area of peak 2 as the second predictive distribution. Calculator 104 may calculate the predictive distribution of the peak shape of peak 1 as the first predictive distribution and calculate the predictive distribution of the peak area of peak 1 as the second predictive distribution. Calculator 104 may calculate the predictive distribution of the peak shape of peak 1 as the first predictive distribution and calculate the predictive distribution of the peak area of peak 2 as the second predictive distribution. Note that when, for example, a comparison is made between two measured waveforms obtained by the prescribed measurement performed by sample measurement device 10, it cannot be said that the first and second predictive distributions are related to each other.

As the display mode of the first and second predictive distributions, only the first predictive distribution may be displayed, only the second predictive distribution may be displayed, or both the predictive distributions may be displayed. When both the predictive distributions are displayed, one of them may be displayed larger and the other may be displayed smaller.

Specifically, for example, at S13, a display item may be input so as to display the predictive distribution of the peak shape of peak 1, causing display 112 to display the predictive distribution of the peak shape of only peak 1. At S13, also, a display item may be input so as to display the predictive distribution of the peak shape of peak 1 to be larger and display the predictive distribution of the peak shape of peak 2 to be smaller, causing display 112 to display the predictive distribution of the peak shape of peak 1 to be larger and display the predictive distribution of the peak shape of peak 2 to be smaller.

### Predictive Distribution of Peak Shape

As described above, acquisition unit 101 obtains a measured waveform (also referred to as “signal waveform”) obtained by the prescribed measurement performed by sample measurement device 10. Estimator 102 estimates the predictive distribution of each wave shape for a corresponding one of a plurality of peak waveforms, which are included in the measured waveform obtained by acquisition unit 101 and are close to each other, using a prescribed peak shape model by Bayesian estimation. The estimation and display of the predictive distribution of the peak shape will be specifically described below.

The present embodiment assumes the case where a plurality of peaks are superimposed on each other in a chromatogram and the number of superimposed peaks is unknown. In such a case, generally, to perform peak separation from a signal waveform, models for the individual peak shapes are added up to create a model of the signal waveform, and parameters of the model are adjusted for fitting to the signal waveform.

In the present embodiment, an LC chromatogram is applied as the measured waveform (signal waveform). Also, a BEMG function is applied as the prescribed peak shape model. In other words, one peak shape is expressed by Equation (3) below.

$$\begin{matrix}[ Math 3 ] & \\ BEMG ( x \vert u , s , a , b ) = \frac{a b}{2 a + 2 b} \{ exp ( \frac{{b}^{2} {s}^{2}}{2} + b ( u - x ) ) * erfc ( \frac{b {s}^{2} + u - x}{\sqrt{2 s}} ) + exp ( \frac{{a}^{2} {s}^{2}}{2} + a ( x - u ) ) * erfc ( \frac{a {s}^{2} - u + x}{\sqrt{2 s}} ) \} & ( 3 )\end{matrix}$$

Since the signal waveform is regarded as the superimposition of peaks, a signal waveform model can be expressed by adding up a plurality of BEMG functions. In the present embodiment, what obtained by adding up K number of BEMG functions (the number of peaks=K) is referred to as “K-mixture BEMG function”. The K-mixture BEMG function is represented by Equation (4) below. However, an error term ε is added as in (4) in consideration of noise contamination in a signal. Error term ε is normally distributed with zero average, and its distribution is estimated from a signal waveform as a parameter.

$$\begin{matrix}[ Math 4 ] & \\ y = {\sum }_{i = 1}^{K} {A}_{i} \times B E M G ( x \vert {u}_{i} , {s}_{i} , {a}_{i} , {b}_{i} ) + ε & ( 4 )\end{matrix}$$

Although the BEMG function is applied as the model of the peak shape in the present embodiment, the present invention is not limited thereto. For example, the Gaussian function or the Cauchy function may be applied as the model of the peak shape, or any model that can be described with some model function may be applied. The error term may be as represented by Equation (5) below in which an error is added to x or Equation (6) below in which an input x affects an error. Although the error term is normally distributed in the present embodiment, the present invention is not limited thereto. For example, the error term may follow any other probability distribution or follow a rule other than the probability distribution.

$$\begin{matrix}[ Math 5 ] & \\ y = {\sum }_{i = 1}^{K} {A}_{i} \times B E M G ( x + ε \vert {u}_{i} , {s}_{i} , {a}_{i} , {b}_{i} ) & ( 5 )\end{matrix}$$

$$\begin{matrix}[ Math 6 ] & \\ y = {\sum }_{i = 1}^{K} {A}_{i} \times B E M G ( x \vert {u}_{i} , {s}_{i} , {a}_{i} , {b}_{i} ) + ε ( x ) & ( 6 )\end{matrix}$$

In Bayesian estimation, for example, it suffices that distribution estimation is performed through sampling with a No U-Turn Sampler (NUTS). Note that the present invention is not limited thereto, and any other sampling technique may be used. Alternatively, for example, Bayesian estimation technique other than sampling, such as variational Bayes, may be used.

As described with reference to FIG. 1, when the peak of a substance (also referred to as “main peak”, “peak 1”) and the peak of an impurity (also referred to as a “shoulder peak”, “peak 2”) are close to each other, it is difficult to distinguish between these peaks.

In the case of FIG. 1, the number of peaks may be one (there is only the main peak), the number of peaks may be two (there are the main peak and the shoulder peak). Alternatively, the number of peaks may be three or more.

In the present embodiment, thus, the predictive distribution of the peak shape is estimated assuming that the number of peaks is one or two or more. Specifically, the present embodiment has a configuration in which, for each of the cases where the number of peaks is 1 to N, the predictive distribution of the peak shape can be estimated, and an estimation result can be displayed on display 112. Further, the present embodiment has a configuration that allows the user to determine and set an appropriate number of peaks based on the comparison between the predictive distributions of peak shapes for the respective numbers of peaks.

A specific example will be described below with reference to FIGS. 5 to 7. FIG. 5 shows a display example of a predictive distribution of a peak shape when the number of peaks is assumed to be two. FIG. 6 shows a display example of a predictive distribution of a peak shape when the number of peaks is assumed to be one.

The posterior distribution of parameters is obtained as an estimate by Bayesian estimation. A predictive amount (predictive distribution) of each peak shape is generated from this estimate. FIGS. 5 and 6 each depict a peak shape estimated from the posterior distribution of each parameter. Here, the solid line indicates an observed waveform. The region surrounded by the dashed line indicates a two-sided 95% prediction interval of the predictive distribution of the signal waveform obtained from the estimate (the posterior distribution of parameters of the model).

As shown in FIG. 6, when the number of peaks is assumed to be one (1-mixture BEMG function model is applied), the right portion of the peak has a wider predictive distribution, and accordingly, it is confirmed that a large error has occurred. In contrast, when the number of peaks is assumed to be two (2-mixture BEMG function model is applied) as shown in FIG. 5, the right portion of the peak has a smaller error than when the number of peaks is assumed to be one.

Though not shown, the predictive distribution of the peak shape when the number of peaks is three, four . . . or N can also be displayed. When the user judges that an appropriate number of peaks is two, the user sets the number of peaks to two by operating keyboard 111. Thus, the predictive distribution of the peak shape in the case where the number of peaks is two is selected as an estimation result. Also, based on this predictive distribution of the peak shape, the predictive distribution of the quantitative indicator or the like is calculated.

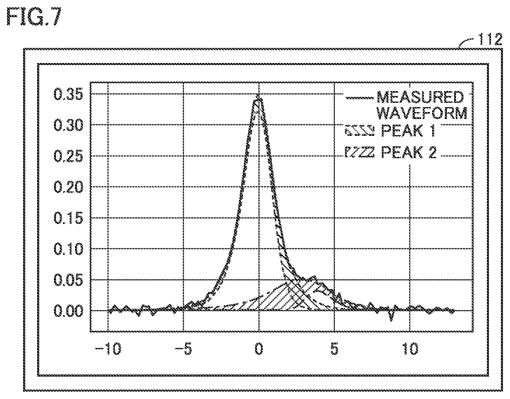

FIG. 7 shows a display example of the predictive distribution of each peak shape when the number of peaks is assumed to be two. Here, the solid line indicates an observed waveform (measured waveform). The region surrounded by the dashed line indicates a 95% prediction interval of peak 1 (main peak). The region surrounded by the alternate long and short dash line indicates a 95% prediction interval of peak 2 (shoulder peak) shape. FIG. 7 is obtained by substituting the posterior distribution of parameters Aᵢ, uᵢ, sᵢ, aᵢ, bᵢ (a sample obtained from the posterior distribution when Bayesian estimation is performed through sampling) into the model. FIG. 7 shows the predictive distribution of the peak shape per se excluding an error term.

It is found that as shown in FIG. 7 that peak 2 (shoulder peak) is present close to the right side of peak 1 (main peak). In the example of FIG. 1, it is a case where only the main peak is present that the number of peaks is one, and it is a case where an impurity peak (shoulder peak) is present in addition to the main peak that the number of peaks is two. When tailing occurs due to peaks being close to each other, tailing and an impurity peak are superimposed on each other, increasing uncertainty. Such uncertainty can be evaluated by predictive distribution using a technique such as Bayesian estimation, as described above.

In the present embodiment, the user visually checks which of the numbers of peaks 1 to N is appropriate and selects (sets) an optimum number of peaks, as described above. However, the present invention is not limited thereto, and data processing device 100 may select an optimum number of peaks. In this case, an optimum number of peaks may be automatically selected using a criterion such as information criterion or Bayes factor. For example, in the use of the information criterion as a criterion, when any of multiple models is selected, a model with a minimum evaluation value is selected as an appropriate model.

Alternatively, both the user and data processing device 100 may select the number of peaks. For example, the predictive distribution of the peak shape in each of the cases where the number of peaks is 1 to N is displayed, and the number of peaks selected by data processing device 100 is displayed. In this case, the user visually determines an appropriate number of peaks, and when this number of peaks is different from the number of peaks selected by data processing device 100, the selected number can be changed to the number of peaks determined by the user.

### Predictive Distribution of Quantitative Indicator and Quantile

Calculator 104 calculates the predictive distribution of the quantitative indicator for each peak waveform based on the predictive distribution of the peak shape estimated by estimator 102, as described above. Display processor 105 performs the process of causing display 112 to display the predictive distribution of the quantitative indicator calculated by calculator 104.

Here, the quantitative indicator includes at least the height of the peak shape (also referred to as “peak height”) and the area of the peak shape (also referred to as “peak area”). Alternatively, the quantitative indicator may include the concentration of a substance (also referred to as “substance concentration”) calculated from the peak height or the peak area. “Substance concentration” refers to the concentration of a substance that is contained in a sample and corresponds to each peak.

FIG. 8 shows a display example of predictive distributions of peak areas. The example of FIG. 8 is obtained by calculating the predictive distribution of the peak area by calculator 104 as the quantitative indicator based on the predictive distribution of each peak shape when the number of peaks is two in the example of FIG. 7, and causing display 112 to display this predictive distribution.

The predictive distribution of the peak area of peak 1 (main peak) is calculated in the left side of FIG. 8, the predictive distribution of the peak area of peak 2 (shoulder peak) is calculated in the right side of FIG. 8, and the calculation results are plotted as a violin plot. Here, the vertical axis represents a peak area, and the horizontal axis represents the probability density of peak 1 or peak 2 bilaterally symmetrically.

The peak area of peak 2 (shoulder peak) has an average of 0.130, a median of 0.113, and a two-sided 95% predictive interval of [0.079, 0.278]. As shown in the diagram, the distribution profile is vertically asymmetric, and the upper end thereof extends up to 0.5. Accordingly, it is seen visually or intuitively with ease that the distribution profile may have a very large value. It is also seen intuitively from the diagram with ease that the area of the peak 1 is approximately 1.0 and the area of peak 2 is approximately 0.1 and that the area of peak 2 is approximately one-tenth the area of peak 1.

Though not shown in the diagram, the predictive distributions can be calculated also for the peak height and the substance concentration based on the predictive distribution of the peak shape estimated by estimator 102 described above, and the predictive distributions can be displayed on display 112, as in the example of FIG. 8. Such displays are switchable by a user's operation. In plotting, when there is a probability distribution of two variables, the probabilities corresponding to all the values that one variable can take are added up and subjected to marginalization, thereby obtaining the other probability distribution. Then, the obtained probability distribution is plotted.

The predictive distribution of the quantitative indicator includes the distribution of a ratio of a substance corresponding to each peak shape. For example, when the quantitative indicator is “the ratio of peak heights between peak shapes (also merely referred to as “height ratio”)”, the predictive distribution of the quantitative indicator is the predictive distribution of the height ratio. When the quantitative indicator is “the ratio of peak areas between peak shapes (also merely referred to as “area ratio”)”, the predictive distribution of the quantitative indicator is the predictive distribution of the area ratio. When the quantitative indicator is “the ratio of concentrations between substances (also merely referred to as “concentration ratio”)”, the predictive distribution of the quantitative indicator is the predictive distribution of the concentration ratio.

For example, in the above-mentioned example with peak 1 and peak 2, the area ratio=“the peak area of peak 2/the peak area of peak 1”. When peak 2 corresponds to an impurity, the area ratio refers to the ratio of the impurity to the substance corresponding to peak 1. The area ratio may be equal to “the peak area of peak 2/(the peak area of peak 1+the peak area of peak 2)”. Alternatively, when there are N number of peaks, the area ratio may be equal to “the peak area of one peak/the sum of peak areas of peaks 1 to N”, or the area ratio may be determined for two peaks that are to be compared.

When peak areas are displayed as shown in FIG. 8, the peak areas may be displayed simultaneously for a plurality of peaks or may be displayed while switching one by one. When the area ratios are displayed as in FIG. 9, which will be described next, a plurality of area ratios may be displayed simultaneously or may be displayed while switching one by one.

FIG. 9 shows a display example of a predictive distribution of an area ratio and a quantile. FIG. 9 shows a histogram and kernel density estimation thereof.

Input receiver 103 receives an input of a threshold based on a user's operation, as described above. Calculator 104 calculates a predictive distribution of a quantitative indicator for each peak waveform based on the predictive distribution of the peak shape estimated by estimator 102, and calculates a quantile at a threshold in the calculated predictive distribution of the quantitative indicator. Display processor 105 is operable to display, as the quantile, the probability at which the quantitative indicator is equal to or more than or is equal to or less than the threshold received by input receiver 103.

In this example, “area ratio” is input as the quantitative indicator, and “0.95” is input as the threshold. Calculator 104 calculates the predictive distribution of the area ratio for each peak waveform based on the predictive distribution of the peak shape estimated by estimator 102, and calculates the quantile at the threshold (0.95) in the calculated predictive distribution of the area ratio. Display processor 105 displays, as the quantile, the probability that the quantitative indicator is equal to or more than the threshold (0.95) received by input receiver 103.

In the example of FIG. 9, quantile “20.4%” is calculated, and “P (area [%]<20.4)=0.95” is displayed. This indicates that the area ratio (the peak area of peak 2/the peak area of peak 1) is less than 20.4% with a probability (level of security) of 0.95 (95%). In this example, “0.95” is input as the threshold, and the quantile determined for this threshold is “20.4%”. Though not shown in FIG. 8, the peak area of peak 1 and the peak area of peak 2 have a one-to-one correspondence as internal data. Thus, the area ratio=the peak area of peak 2/the peak area of peak 1 is determined uniquely.

Alternatively, it may be indicated that the area ratio is equal to or more than 20.4% with a probability of 0.05 (5%). In this case, “0.05” is input as the threshold, and the quantile determined for this threshold is “20.4%”. Display processor 105 displays, as the quantile, the probability that the quantitative indicator is equal to or less than the threshold (0.05) received by input receiver 103. For example, “P (area [%]≥20.4)=0.05” may be displayed.

In this case, it can also be said that the probability (level of significance) with which the area ratio of peak 2 (shoulder peak) to peak 1 is equal to or more than 20.4% is 5% (=1−0.95). Alternatively, the area ratio may be input as the threshold, and the level of significance may be calculated. For example, when the user inputs “20.4%” as the threshold, the level of significance=“5%” is calculated as the quantile.

Display processor 105 is operable to display a percentile point of a predictive distribution of a quantitative indicator which corresponds to the threshold received by input receiver 103. In this example, a 95% point is 0.204. As shown in FIG. 9, the 95% point is indicated by the vertical dashed line as the percentile point. Unlike a normal prediction interval, such an intuitive interpretation is possible in the prediction interval in Bayesian estimation.

Although the number of peaks is two in the above example, there may be three or more peaks. In this case, there are predictive distributions, as shown in FIG. 8, for the number of peaks. In this case, any two of these peaks may be selected, and a predictive distribution of an area ratio as shown in FIG. 9 may be displayed.

Although the level of significance is 5% (the threshold is 0.95) here, this threshold can be specified by the user as described above. Upon specification of the level of significance, a value that can be taken within the range of the specified level of significance can be determined for the area ratio of the impurity peak.

When input receiver 103 newly receives an input of a threshold, display processor 105 may be operable to display the percentile point again while bringing the percentile point into correspondence with the newly received threshold.

For example, when display processor 105 displays the percentile point based on the threshold “0.95” upon input of “0.95” to input receiver 103 as the threshold, and then, “0.97” is input to input receiver 103 as the threshold, display processor 105 may display the percentile point based on the threshold “0.97”.

Specifically, after “0.95” (the level of significance 5%) is set as the threshold and then display as shown in FIG. 9 is provided, the threshold can be changed (e.g., “0.97” (the level of significance 3%)) to update the display. In this case, for example, the user can verify that the area ratio of the shoulder peak is equal to or more than 20.4% when the level of significance is 5%, and that the area ratio of the shoulder peak is equal to or more than 22% when the level of significance is 3%. In this case, the percentile point is also changed to be displayed. As described above, the user can set and update any value as the threshold and display a result of the setting and update on display 112, thereby performing evaluation and verification.

There is a strong need for the evaluation and verification as described above especially in the field of impurity analysis of medical and pharmaceutical products. Pharmaceutical impurities, which are unnecessary chemical substances remaining in active ingredients of medical and pharmaceutical products, are required to be reported if such impurities are contained at a prescribed concentration or more. Also, when peaks are close to each other between an active ingredient and an impurity or between impurities, an error is especially likely to occur as described above. Under the circumstances, there is a strong need for grasping risk, such as how much error has occurred for the concentration of impurities.

Though not shown, the predictive distributions of the height ratio and the concentration ratio can also be calculated and displayed on display 112, as in the example of FIG. 9. In this case, the percentile point and the quantile of the predictive distributions of the height ratio and the concentration ratio are also displayed based on the threshold. Such displays are switchable by a user's operation.

The display of the quantile, described with reference to FIG. 9, is not limited to the display together with the predictive distribution of the area ratio. For example, the quantile may be displayed together with the predictive distribution of an individual peak shape. FIG. 10 shows a display example of the predictive distribution of each peak shape and the quantile. In this case, the display item “peak shape” is input as “quantitative indicator”, and the predictive distribution (95% prediction interval for each peak) of the peak shape is displayed on display 112.

As shown in FIG. 10, “P (area [%]<20.4)=0.95” is displayed together with the predictive distribution of an individual peak shape. It is thus indicated that the peak area of peak 2/the peak area of peak 1 (area ratio) is less than 20.4% with a probability of 0.95 (95%).

As described above, the user can check the predictive distribution of the quantitative indicator, and accordingly, the statistical data on the quantitative indicator can be grasped intuitively with ease. Also, a reasonable level of security can be secured in consideration of an error against the quantitative indicator through such checking. Also, the user can check the quantile at the threshold in the predictive distribution of the quantitative indicator. Accordingly, the reasonable level of security can be secured in consideration of an error against the quantitative indicator.

For example, the area ratio can be used as the quantitative indicator. In this case, determination with a secured reasonable level of security is enabled for each peak substance by considering an area error of each peak. In component determination in a chromatograph, the concentration of each component is normally proportional to a peak height or a peak area, and thus, the predictive distribution of the component concentration is obtained. Based on this predictive distribution, a possibility that each substance will exceed a threshold established by a law or regulation can be evaluated. When the number of peak functions (the number of peaks) applied to a chromatogram is also to be estimated, the probability of the presence or absence of an impurity can also be evaluated.

### Functional Configuration of Analysis Device

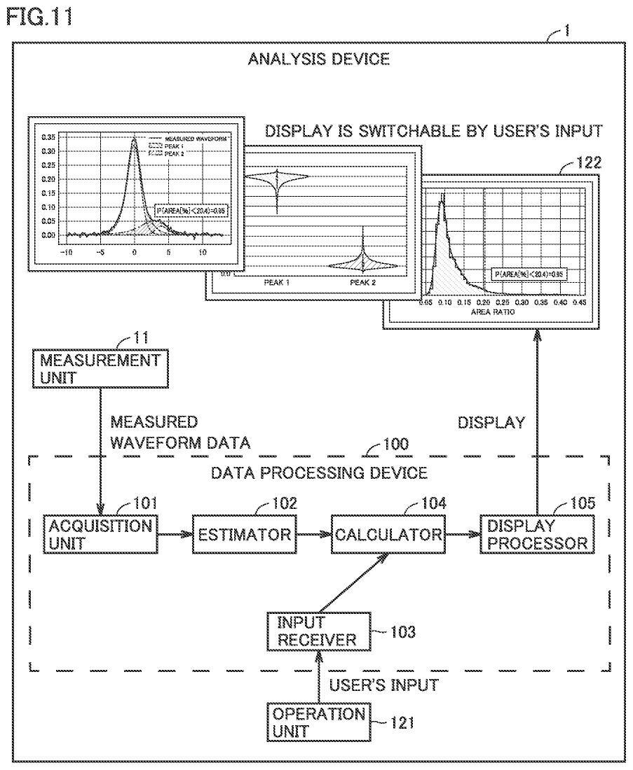

FIG. 11 is a block diagram showing a functional configuration example of an analysis device according to a variation of the present embodiment.

The present embodiment has a configuration in which sample measurement device 10 performs a prescribed measurement of a sample, and acquisition unit 101 of data processing device 100 obtains a measured waveform obtained by the prescribed measurement performed by sample measurement device 10, as shown in FIG. 2.

In contrast, analysis device 1 according to the variation of the present embodiment includes data processing device 100 and a measurement unit 11. Measurement unit 11 performs a prescribed measurement of a sample. Acquisition unit 101 obtains a measured waveform obtained by the prescribed measurement performed by measurement unit 11.

In other words, sample measurement device 10 different from data processing device 100 performs a prescribed measurement of a sample in the present embodiment, whereas measurement unit 11 included in analysis device 1 performs a prescribed measurement of a sample in the variation of the present embodiment.

In this case, for example, analysis device 1 includes measurement unit 11, acquisition unit 101, estimator 102, input receiver 103, calculator 104, display processor 105, operation unit 121, and display unit 122, as shown in FIG. 11.

Analysis device 1 is, for example, a chromatograph analyzer (LC, GC) or a chromatograph mass spectrometer (LC/MS, GC/MS) as described above. Measurement unit 11 is a device that performs a prescribed measurement of a sample, and data processing device 100 is a device that performs the data process on an obtained measured waveform. In other words, analysis device 1 is a device including a device for measurement and a device for data processing. Data processing device 100 may be a substrate or a module that performs the data process.

Data processing device 100 includes acquisition unit 101, estimator 102, input receiver 103, calculator 104, and display processor 105, and details of the processes performed by these components are similar to those described with reference to FIGS. 1 to 10. Data processing device 100 receives input of an operation from the user by operation unit 121 included in data processing device 100 and displays it on display unit 122 included in data processing device 100.

The present embodiment assumes that, for example, a program that performs a data process on a measured waveform is installed in a personal computer connected to an LC analysis device or that the personal computer connects to a server device that executes a program that performs the data process on a measured waveform, whereas the variation of the present embodiment has a configuration in which an LC analysis device itself executes a program that performs the data process on a measured waveform.

### Aspects

It will be appreciated by a person skilled in the art that the embodiment and the variation thereof described above provide specific examples of the following aspects.

(Clause 1) A data processing device according to an aspect performs a data process on a measured waveform obtained by a prescribed measurement of a sample. The data processing device includes an estimator, a calculator, and a display processor. The estimator estimates a predictive distribution of each peak shape for a corresponding one of a plurality of peak waveforms using a prescribed peak shape model, the plurality of peak waveforms being included in the measured waveform and being close to each other. The calculator calculates a predictive distribution of a quantitative indicator for each of the plurality of peak waveforms based on the predictive distribution of the peak shape estimated by the estimator. The display processor is operable to display the predictive distribution of the quantitative indicator calculated by the calculator.

With the above configuration, the user can check the predictive distribution of the quantitative indicator, and accordingly, statistical data on the quantitative indicator can be grasped intuitively with ease. Also, the reasonable level of security can be secured in consideration of an error against the quantitative indicator through such checking.

(Clause 2) In the data processing device according to clause 1, the calculator calculates a quantile at a threshold in the calculated predictive distribution of the quantitative indicator. The display processor is operable to display the quantile calculated by the calculator.

With the above configuration, the user can check the quantile at the threshold in the predictive distribution of the quantitative indicator. Accordingly, the reasonable level of security can be secured in consideration of an error against the quantitative indicator.

(Clause 3) The data processing device according to clause 1 or 2 further includes an input receiver that receives a user's input. The calculator calculates, based on the predictive distribution of the peak shape estimated by the estimator, a first predictive distribution and a second predictive distribution for each of the plurality of peak waveforms, the first predictive distribution and the second predictive distribution being related to each other and being based on the quantitative indicator. The display processor is operable to change a display mode of the first predictive distribution and the second predictive distribution based on a user's selection received by the input receiver.

With the above configuration, the display mode of the first and second predictive distributions can be changed based on the user's selection, for example, only the first predictive distribution is displayed or only the second predictive distribution is displayed. Accordingly, the statistical data on the quantitative indicator can be grasped intuitively with ease.

(Clause 4) The data processing device according to clause 2 further includes an input receiver that receives a user's input. The display processor is operable to display, as the quantile, a probability that the quantitative indicator is equal to or more than or is equal to or less than the threshold received by the input receiver.

With the above configuration, an evaluation can be performed preferably based on the quantile calculate based on the threshold input according to the user's will.

(Clause 5) The data processing device according to clause 2 further includes an input receiver that receives a user's input. The display processor is operable to display a percentile point of the predictive distribution of the quantitative indicator, the percentile point corresponding to the threshold received by the input receiver.

With the above configuration, an evaluation can be performed preferably based on the percentile point indicated based on the threshold input according to the user's will.

(Clause 6) In the data processing device according to clause 5, the display processor is operable to, when the input receiver newly receives an input of the threshold, display the percentile point again while bringing the percentile point into correspondence with the newly received threshold.

With the above configuration, an evaluation can be performed preferably based on the percentile point indicated based on the threshold changed according to the user's will.

(Clause 7) In the data processing device according to any one of clauses 1 to 6, the quantitative indicator includes at least a height of the peak shape and an area of the peak shape.

With the above configuration, an evaluation can be performed preferably on, for example, a specific substance such as a main component or an impurity.

(Clause 8) In the data processing device according to clause 7, the predictive distribution of the quantitative indicator includes a distribution of a ratio of a substance, the distribution corresponding to each peak shape.

With the above configuration, for example, an evaluation can be performed preferably on a ratio of an impurity to a main component or a ratio between impurities.

(Clause 9) In the data processing device according to any one of clauses 1 to 8, the estimator estimates the predictive distribution of each peak shape by Bayesian estimation.

With the above configuration, an evaluation can be performed preferably on the quantitative indicator.

(Clause 10) An analysis device includes the data processing device according to any one of clauses 1 to 9, and a measurement unit that performs the prescribed measurement of the sample.

With the above configuration, the prescribed measurement of the sample and the evaluation of the quantitative indicator can be performed by only a single device (analysis device).

(Clause 11) A data processing method according to one aspect performs a data process on a measured waveform obtained by a prescribed measurement of a sample. The data processing method includes: estimating a predictive distribution of each peak shape for a corresponding one of a plurality of peak waveforms using a prescribed peak shape model, the plurality of peak waveforms being included in the measured waveform and being close to each other; calculating a predictive distribution of a quantitative indicator for each of the plurality of peak waveforms based on the estimated predictive distribution of the peak shape; and displaying the calculated predictive distribution of the quantitative indicator.

With the above configuration, the user can check the predictive distribution of the quantitative indicator, and accordingly, statistical data on the quantitative indicator can be grasped intuitively with ease. Also, the reasonable level of security can be secured in consideration of an error against the quantitative indicator through such checking.

(Clause 12) The data processing method according to clause 11 further includes: calculating a quantile at a threshold in the calculated predictive distribution of the quantitative indicator; and displaying the calculated quantile.

With the above configuration, the user can check the quantile at the threshold in the predictive distribution of the quantitative indicator. Accordingly, the reasonable level of security can be secured in consideration of an error against the quantitative indicator.

(Clause 13) The data processing method according to clause 11 or 12 further includes: receiving a user's input; based on the estimated predictive distribution of the peak shape, calculating a first predictive distribution and a second predictive distribution for each of the plurality of peak waveforms, the first predictive distribution and the second predictive distribution being related to each other and being based on the quantitative indicator; and changing a display mode of the first predictive distribution and the second predictive distribution based on a user's selection received.

With the above configuration, the display mode of the first and second predictive distributions can be changed based on the user's selection, for example, only the first predictive distribution is displayed or only the second predictive distribution is displayed. Accordingly, the statistical data on the quantitative indicator can be grasped intuitively with ease.

(Clause 14) A data processing program according to an aspect performs a data process on a measured waveform obtained by a prescribed measurement of a sample. The data processing program causes a computer to perform the steps of: estimating a predictive distribution of each peak shape for a corresponding one of a plurality of peak waveforms using a prescribed peak shape model, the plurality of peak waveforms being included in the measured waveform and being close to each other; calculating a predictive distribution of a quantitative indicator for each of the plurality of peak waveforms based on the estimated predictive distribution of the peak shape; and displaying the calculated predictive distribution of the quantitative indicator.

With the above configuration, the user can check the predictive distribution of the quantitative indicator, and accordingly, statistical data on the quantitative indicator can be grasped intuitively with ease. Also, the reasonable level of security can be secured in consideration of an error against the quantitative indicator through such checking.

It is to be understood that the embodiment disclosed herein is presented for the purpose of illustration and non-restrictive in every respect. It is therefore intended that the scope of the present invention is defined by claims, not only by the embodiment described above, and encompasses all modifications and variations equivalent in meaning and scope to the claims.

### Industrial Applicability

The present disclosure is used to determine a peak area (or a peak height or a concentration) of each substance included in a sample or to evaluate its robustness (evaluate a quantitative indicator) when peak separation is important due to the superimposition of a plurality of peaks which is caused by a measured waveform of a chromatograph or the like including, for example, a plurality of peak waveforms that are close to each other.

### Reference Signs List

1 analysis device; 10 sample measurement device; 11 measurement unit; 100 data processing device; 101 acquisition unit; 102 estimator; 103 input receiver; 104 calculator; 105 display processor; 111 keyboard; 112 display; 121 operation unit; 122 display unit.

1. A data processing device that performs a data process on a measured waveform obtained by a measurement of a sample, the data processing device comprising:
an estimator that outputs a predictive distribution of each peak shape for a corresponding one of a plurality of peak waveforms using a peak shape model, the plurality of peak waveforms being included in the measured waveform and closely appearing to each other;
a calculator that outputs, based on the outputted predictive distribution of the peak shape from the estimator, a predictive distribution of a quantitative indicator for each of the plurality of peak waveforms; and
a display processor operable to display the outputted predictive distribution of the quantitative indicator from the calculator,
wherein the calculator outputs, based on the outputted predictive distribution of the peak shape from the estimator, a first predictive distribution and a second predictive distribution for each of the plurality of peak waveforms, the first predictive distribution and the second predictive distribution being related to each other and being based on the quantitative indicator, and
wherein the display processor is operable to change a display mode of the first predictive distribution and the second predictive distribution.

2. The data processing device according to claim 1, wherein
the calculator calculates a quantile at a threshold in the outputted predictive distribution of the quantitative indicator, and
the display processor is operable to display the quantile calculated by the calculator.

3. The data processing device according to claim 1, further comprising an input receiver that receives a user's input, wherein
the calculator outputs, based on the outputted predictive distribution of the peak shape from the estimator, a first predictive distribution and a second predictive distribution for each of the plurality of peak waveforms, the first predictive distribution and the second predictive distribution being related to each other and being based on the quantitative indicator, and
the display processor is operable to change a display mode of the first predictive distribution and the second predictive distribution based on a user's selection received by the input receiver.

4. The data processing device according to claim 2, further comprising an input receiver that receives a user's input,
wherein the display processor is operable to display, as the quantile, a probability that the quantitative indicator is equal to or more than or is equal to or less than the threshold received by the input receiver.

5. The data processing device according to claim 2, further comprising an input receiver that receives a user's input,
wherein the display processor is operable to display a percentile point of the predictive distribution of the quantitative indicator, the percentile point corresponding to the threshold received by the input receiver.

6. The data processing device according to claim 5, wherein the display processor is operable to, when the input receiver newly receives an input of the threshold, display the percentile point again while bringing the percentile point into correspondence with the newly received threshold.

7. The data processing device according to claim 1, wherein the quantitative indicator includes at least a height of the peak shape and an area of the peak shape.

8. The data processing device according to claim 7, wherein the predictive distribution of the quantitative indicator includes a distribution of a ratio of a substance, the distribution corresponding to each peak shape.

9. The data processing device according to claim 1, wherein the estimator outputs the predictive distribution of each peak shape by Bayesian estimation.

10. An analysis device comprising:
the data processing device according to claim 1; and
a measurement unit that performs the measurement of the sample.

11. A data processing method of performing a data process on a measured waveform obtained by a measurement of a sample, the data processing method comprising:
outputting a predictive distribution of each peak shape for a corresponding one of a plurality of peak waveforms using a peak shape model, the plurality of peak waveforms being included in the measured waveform and closely appearing to each other;
outputting, based on the outputted predictive distribution of the peak shape, a predictive distribution of a quantitative indicator for each of the plurality of peak waveforms;
displaying the outputted predictive distribution of the quantitative indicator;
outputting, based on the outputted predictive distribution of the peak shape, a first predictive distribution and a second predictive distribution for each of the plurality of peak waveforms, the first predictive distribution and the second predictive distribution being related to each other and being based on the quantitative indicator; and
changing a display mode of the first predictive distribution and the second predictive distribution.

12. The data processing method according to claim 11, further comprising:
calculating a quantile at a threshold in the outputted predictive distribution of the quantitative indicator; and
displaying the calculated quantile.

13. The data processing method according to claim 11, further comprising:
receiving a user's input;
based on the outputted predictive distribution of the peak shape, outputting a first predictive distribution and a second predictive distribution for each of the plurality of peak waveforms, the first predictive distribution and the second predictive distribution being related to each other and being based on the quantitative indicator; and
changing a display mode of the first predictive distribution and the second predictive distribution based a user's selection received.

14. (canceled)

15. The data processing device according to claim 1, wherein
the plurality of peak waveforms include a first peak waveform and a second peak waveform,
the quantitative indicator includes a first quantitative indicator and a second quantitative indicator, and
the change of the display mode of the first predictive distribution and the second predictive distribution includes a change selected from the group consisting of
a change from a display of the outputted first predictive distribution for the first peak waveform from the calculator to a display of the outputted second predictive distribution for the second peak waveform from the calculator, and
a change from the display of the outputted first predictive distribution based on the first quantitative indicator from the calculator to a display of the outputted second predictive distribution based on the second quantitative indicator from the calculator.
